(19) United States
(12) Patent Application Publication
(10) Pub. No.: US 2009/0059866 A1
(43) Pub. Date: Mar. 5, 2009

(54) METHOD, SYSTEM AND APPARATUS FOR IMPLEMENTING FAST HANDOVER

(75) Inventors: Hongfei Chen, Shenzhen (CN); Zhongqi Xia, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/264,537

(22) Filed: Nov. 4, 2008

Related U.S. Application Data
(63) Continuation of application No. PCT/CN2007/001553, filed on May 14, 2007.

(30) Foreign Application Priority Data
Jun. 24, 2006 (CN) 200610061345.3

(51) Int. Cl. H04W 4/00

(52) U.S. Cl. 370/331; 370/338

(57) ABSTRACT

A method, a system and an apparatus for fast handover, and relates to the field of mobile communication. The method is to create a fixed tunnel relationship between the PAR and the NAR, where a current host route of an MN at the access routers PAR and NAR is created; and the access routers (PAR and NAR) and the MN encapsulating a message according to the current host route information of the MN, and transferring the message through a tunnel. The apparatus includes a tunnel creating module, a host route creating module, a neighbor relationship creating module, and a transferring module. The technical solution under the present disclosure needs to create only one tunnel, which improves the router efficiency greatly and makes the handover process smoother.

### CROSS-REFERENCE TO RELATED APPLICATIONS

This application is a continuation of International Application No. PCT/CN2007/001553, filed on May 14, 2007, which claims priority to Chinese Patent Application No. 200610061345.3, filed with the Chinese Patent Office on Jun. 24, 2006 and entitled “Method and Apparatus for Implementing Fast Handover”, both of which are incorporated herein by reference in their entireties.

### FIELD

The present disclosure relates to the mobile communication field, and in particular, to a method, system and apparatus for implementing fast handover in mobile IP Version 6 (IPv6).

### BACKGROUND

The statements in this section merely provide background information related to the present disclosure and may not constitute prior art.

With development of network technologies and emergence of miscellaneous movable terminals such as notebook computer, palm computer, mobile phone, vehicle-mounted device, mobile computer is now prevalent. More and more users use various terminals to access the Internet anywhere through a public mobile radio network. In order to meet the requirements of mobile services, the mobile IP technology is introduced onto the network layer. The basic principles of the mobile IP technology are: a Mobile Node (MN) can always use the initial IP address to perform IP communication in the moving process, thus ensuring the upper-layer applications over the IP network layer to be non-interrupted and routable during motion.

With expansion of the network scale, the IPv6 technology is taking the place of the existing IPv4 technology by virtue of the merits such as huge address space. The IPv6-based mobile IP (namely, mobile IPv6) technology is in the spotlight of the mobile IP field and applied more and more widely now by virtue of its technical advantages and improvement of the mobile IPv4 technology.

FIG. 1 is a topology view of the mobile IPv6, in which the home network 11 is connected with the Internet 10 through a home gateway 110; and the foreign network 12 is connected with the Internet 10 through a foreign gateway 120. A home network is the default network of a node, and its network prefix is the same as that of home IP address of the node. A foreign network is a network other than the home network, and its network prefix is different from that of the home IP address of the node.

An MN 101 is a node that can maintain the underway communication while moving from one network to another on the Internet. One can communicate with an MN only if knowing the home address of the MN. A Correspondence Node (CN) 102 is a node that is communicating with the MN 101 and is of the equivalent standing. The CN may be mobile or fixed. A Home Agent (HA) 103 is a router that has a port connected with the home network of the MN. When an MN moves to a foreign network, it intercepts the information packets sent to the home address of the MN, forward them to the MN through a tunnel mechanism, and handle and maintain the current location information of the MN.

A Care-of Address (CoA) is a relevant IP address obtained when an MN moves to a foreign network. One MN may have multiple CoA addresses concurrently.

The working process of a mobile IPv6 is elaborated hereinafter.

Step A: When an MN is connected to its home network, the MN works in the same way as other fixed nodes. An address is allocated to the MN on the home network, and is called “home address (HoA)”. The HoA is permanently allocated to the MN, and is the same as the address of the fixed node. When the MN moves, its HoA does not change. The mobile IPv6 involves a global unicast HoA and a network-local HoA.

Step B: Through the neighbor discovery mechanism of the IPv6, the MN detects whether it has roamed to a foreign network. The foreign gateway of the IPv6 sends router advertisement messages periodically. The router advertisement messages include the prefix of the foreign network. After receiving the router advertisement message of the foreign gateway, the MN checks the message and finds that the prefix of the foreign network in the message is different from that of the home network, and hence regards the MN as having roamed to the foreign network.

Step C: If the MN finds that it has roamed to a foreign network, the MN obtains the relevant IP address on the foreign network, known as “CoA”, through a stateful or stateless auto address configuration process on the basis of the received router advertisement information. In this case, the MN owns the HoA and the CoA concurrently.

Step D: The MN registers its CoA onto the HA through a “Binding Update” message. The MN can also notify its CN of the CoA through a “Binding Update” registration message. Before registration, a Return Routability detection process needs to be performed between the MN and the CN. Namely, the MN sends a Home Init Test message and a Care-of Init Test message to the CN. The CN handles such messages and returns a Home Test message and a Care-of Test message to the MN.

Step E: Depending on the registration object performed through the “Binding Update” message, a data packet can be transferred in two modes.

The first mode is the triangle routing mode.

If the CN does not know the CoA of the MN, the CN sends the data packets to the home network of the MN according to the HoA of the MN. Afterward, the HA intercepts the data packets, and forwards the data packets to the MN through a tunnel mechanism according to the current CoA of the MN.

The messages sent by the MN to the CN are also sent to the HA through a reversed tunnel, and then the HA forwards the messages to the CN.

In this mode, the packets between the CN and the MN need to be forwarded by the HA, so this mode is called “triangle mode”.

The second mode is the Route optimization mode.

If the CN knows the CoA of the MN through a “Binding Update” message, the CN sends the data packets to the MN directly by using the route header of the IPv6. The first destination address of the data packets is the CoA and the second destination address is the HoA. Therefore, the data packets are directly sent to the MN in the foreign network, without being forwarded by the HA.

In the reversed direction, the source address of the data packet sent by the MN to the CN is the CoA, and the HoA is stored in the destination extension header of the data packet. In this way, a data packet can be sent to the CN directly, without being sent to the HA through a reversed tunnel.

This mode is called “route optimization mode” as against the “triangle route” mode.

Because the handover of the MN of the mobile IPv6 between networks leads to service interruption, the related art provides a fast handover method. Referring to the network architecture shown in FIG. 2, this method introduces the following four new concepts:
PAR: Previous Access Router, the access router of the network before moving;
NAR: New Access Router, the access router of the network after moving;
PCoA: Previous Care-of Address, the CoA of the network before moving;
NCoA: New Care-of Address, the CoA of the network after moving.

According to this fast handover method, before the “Binding Update”, the MN 20 obtains the information about the adjacent network beforehand, and generates the IP address of the adjacent network. Once an action of moving to the adjacent network occurs, a tunnel is created between a PAR 21 and an MN 20 before completion of the binding update to accomplish non-interruption of traffic.

As shown in FIG. 3, the fast handover process in the predictive mode includes the steps as described hereinafter.

Step 301: When the MN is located at the network border between the PAR and the NAR, the MN discovers a new AP signal and an AP ID information. In this case, the MN can send a Router Solicitation for Proxy Advertisement (RtSolPr) message to the PAR, with the newly discovered AP ID information carried in the message, in order to request the router information correlated to the AP ID.

Step 302: The PAR replies with a Proxy Router Advertisement (PrRtAdv) message, with the message carrying the NAR information related to the newly discovered AP ID. The NAR information includes the layer-2 (L2) link address of the NAR, the IP address of the NAR, and the network prefix of the NAR.

Step 303: After the MN receives the PrRtAdv message, the MN generates a correlated NCoA according to the information in the message: if the PrRtAdv message contains the recommended address, the MN uses the address as NCoA; if the PrRtAdv message contains no recommended address, the MN may generate its own NCoA through stateless auto configuration.

When a new AP signal is increasingly stronger, the MN sends a Fast Binding Update (FBU) message to the PAR, with the NCoA of the MN carried in the message.

Step 304: After receiving an FBU message, the PAR sends a Handover Initiation (HI) message to the NAR, with the message carrying the PCoA of the MN, the link-layer address of the MN, and the NCoA of the MN.

Step 305: After receiving a HI message, the NAR checks validity of the NCoA address in the HI message, generates a proxy for the NCoA, and sends a handover acknowledge (Hack) to the PAR.

Step 306: The PAR returns a Fast Binding Acknowledge (FBack) message to the MN and the NAR, stores the corresponding relationship between the NCoA and the PCoA, creates an NCoA tunnel from the PAR to the MN, changes the host route of the PCoA, and changes the next hop of the host route to the tunnel interface.

Step 307: Now a tunnel is created between the PAR and the NCoA of the MN. The PAR sends the buffered message addressed to the PCoA and the newly received message addressed to the PCoA out of this tunnel.

Step 308: After the MN is disconnected from the PAR and handed over to the NAR, the MN sends a Fast Neighbor Advertisement (FNA) message to the NAR. Before completion of binding update, if the NCoA is used as a source IP address, the CN mistakenly regards the message as illegal, and the PCoA is illegal in the NAR network. Therefore, the following operations are performed according to the direction of the data packets.

The traffic sent by the MN to the CN is encapsulated on the MN for tunneling. The source IP address of the inner-layer IP header is PCoA, the destination address is a CN address; the source address of the out-layer IP header is NCoA, and the destination address is a PAR address. The message passes through the NAR and arrives at the PAR. The PAR recognizes the message as a tunnel message according to the mapping relationship between the source address NCoA and PCoA, removes the outer-layer IP header, and uses the inner-layer IP header to continue forwarding the message to the CN.

For the traffic sent by the CN to the MN, the source address of the IP header on the CN is a CN address, and the destination address is a PCoA address. When the message arrives at the PAR, the PAR performs tunnel encapsulation according to the mapping relationship between the NCoA and PCoA. The source address of the outer-layer IP header is a PAR address and the destination address is an NCoA address.

Step 309: After completion of the binding update of the MN, the MN and the PAR delete the tunnel; afterward, the MN uses an NCoA to communicate with the CN directly.

As shown in FIG. 4, the fast handover process in the reactive mode includes the steps as described hereinafter.

Steps 401-402: The MN sends an RtSolPr message and receives a PrRtAdv message on the PAR link, and generates a new NCoA address. Afterward, the MN hands over to the NAR link promptly (before receiving the FBU). The detailed process is elaborated hereinafter.

Step 403: The MN sends a FNA message to the NAR, with the link-layer address of the MN carried in the message. The FNA message also contains an FBU message.

Step 404: After receiving the FNA message, the NAR creates a neighbor entry for the NCoA, and sends an FBU message to the PAR.

Step 405: After receiving the FBU, the PAR creates a mapping relationship between the PCoA and the NCoA, and creates a tunnel from the PAR to the NCoA. The packet arriving at the PAR and addressed to the MN is sent out of this tunnel interface. After completion of the foregoing operations, the PAR sends a FAck message to the NCoA address of the MN.

Now the fast handover signaling between the MN and the PAR and NAR is completed.

Therefore, in the related art, non-interruption of traffic before the MN finishes the binding update of the NCoA is ensured through the tunnel mode between the PAR and MN. However, the tunnel method brings the following problems:
(1) The quantity of MNs in a network is huge, and numerous MNs may hand over between the PAR and the NAR network at a time; because the tunnel forwarding process is much more complicated than the ordinary message forwarding process, the forwarding efficiency of the PAR is reduced drastically;
(2) Because the tunnel between the MN and the PAR is valid only after the MN moves to the NAR before the MN finishes the NCoA binding update, the tunnel life is very short. In a short time, the control module of the router sends a tunnel creation message and a tunnel cancellation message to the forwarding module. When a large quantity of MNs hand over between the PAR and the NAR at a time, a large number of tunnel creation messages and tunnel cancellation messages exist between the control module and the forwarding module of the router, which deteriorates the router performance;
(3) The MN needs to support tunnels, which increases the complexity of the terminal.

### SUMMARY

The present disclosure provides a method, system and apparatus for implementing fast handover, in order to avoid too many temporary tunnels created between the PAR and the MN and increase the forwarding efficiency of the PAR.

The present disclosure provides a fast handover method, which is to create a fixed tunnel relationship between the PAR and the NAR and execute the following steps:
creating the current host route of an MN at the access routers PAR and NAR; and
encapsulating, by the access routers (PAR and NAR) and the MN, a message according to the current host route information of the MN in the MN handover process, and transferring the message through a tunnel.

A fast handover system provided in an embodiment of the present disclosure includes: a Previous Access Router (PAR), a New Access Router (NAR), and a fixed tunnel between the PAR and the NAR.

The PAR includes:
a PAR host route creating module, adapted to create a PCoA host route at the PAR by using the tunnel interface as an egress interface, after receiving a fast binding update message from the MN.

The NAR includes:
an NAR host route creating module, adapted to create a PCoA host route at the NAR, with the ingress interface identical to the interface of the NCoA proxy neighbor list, after receiving a Handover Init message from the PAR; and
an actual host route creating module, adapted to create an actual neighbor list for the NCoA and the PCoA of the MN, and create a host route for the PCoA, after the NAR receives a Fast Neighbor Advertisement (FNA) message from the MN.

A fast handover apparatus provided in an embodiment of the present disclosure includes:
a tunnel creating module, adapted to create a fixed tunnel relationship between the PAR and the NAR;
a host route creating module, adapted to create a current host route of the PCoA at the PAR and NAR;
a neighbor relationship creating module, adapted to create a proxy neighbor list at the NAR for the current PCoA of the MN; and
a transferring module, adapted to transfer the data packet at the access router to the MN according to the found proxy neighbor list.

According to the technical solution under the present disclosure, only one tunnel needs to be created, which increases the efficiency of the router greatly; the data service does not need to be forwarded through an NCoA in the handover process; therefore, for the MN, the NCoA does not need to be configured beforehand, and can be configured after the MN moves to the NAR, thus making the handover process smoother.

### BRIEF DESCRIPTION OF THE DRAWINGS

The disclosure will become more fully understood from the detailed description given herein below for illustration only, and thus is not limitative of the disclosure, and wherein:

FIG. 1 is a network topology view of a mobile IPv6 in the related art;

FIG. 2 is an access network topology view of an MN in the related art;

FIG. 3 is a flowchart of fast handover in the predictive mode in the related art;

FIG. 4 is a flowchart of fast handover in the reactive mode in the related art;

FIG. 5 is a flowchart of the fast handover method in the predictive mode according to an embodiment of present disclosure;

FIG. 6 is a flowchart of the fast handover method in the reactive mode according to an embodiment of present disclosure;

FIG. 7 is a schematic diagram of a fast handover system according to an embodiment of the disclosure; and

FIG. 8 is a schematic diagram of a fast handover apparatus according to an embodiment of the disclosure.

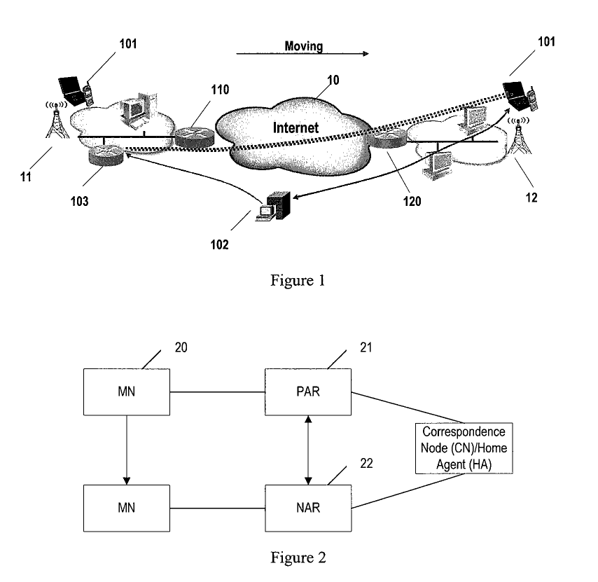

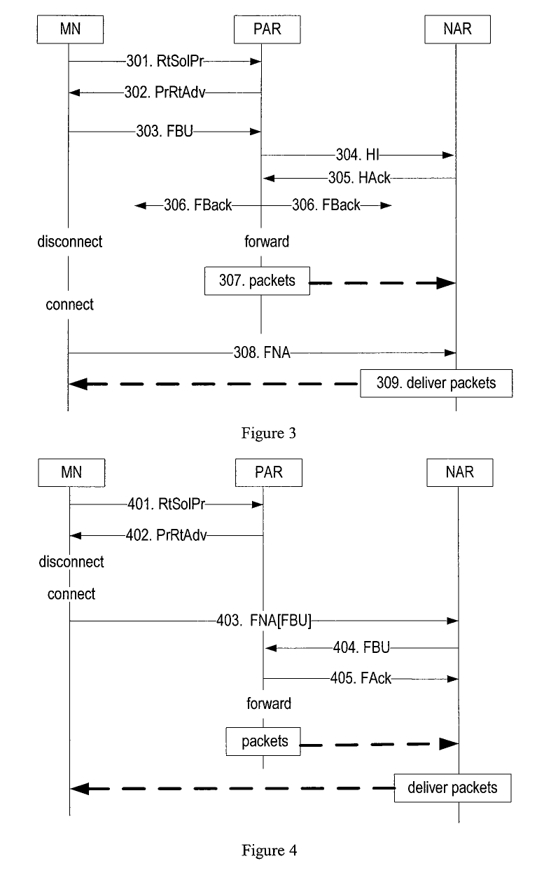

### DETAILED DESCRIPTION

The following description is merely exemplary in nature and is not intended to limit the present disclosure, application, or uses.

The technical solution of the present disclosure is hereinafter described in detail with reference to the embodiments and accompanying drawings.

In an embodiment of the present disclosure, a tunnel is created between the PAR and the NAR for the purpose of transferring transient traffic of the MN during the handover.

For example, the following tunnel is created:
Tunnel static_par nar /*create a new static tunnel, named static_par_nar*/
Source ipaddress par /*the source address of the tunnel is par*/
Destination ipaddress nar /*the destination address of the tunnel is nar*/
exit

The tunnel always exists, and does not need to be frequently created or deleted. The tunnel can be based on various technologies, for example, IP tunnel, IP Security Protocol (IPSEC) tunnel, and Multi Protocol Label Switching (MPLS) tunnel. All MNs that move from a specific PAR to a specific NAR use the same tunnel between the PAR and the NAR for transferring traffic, regardless of the quantity of the MNs. The source of the tunnel on the PAR is a PAR address, the destination address is an NAR address; the source of the tunnel on the NAR is an NAR address, and the destination address is a PAR address.

As shown in FIG. 5, after the tunnel is created, the fast handover method in the predictive mode under the present disclosure includes the steps as described hereinafter.

Step 501: When the MN is located at a PAR network, the MN sends a Router Solicitation for Proxy Advertisement (RtSolPr) message to the PAR to request for the information about the Access Point (AP) and the network; the RtSolPr message may be sent at the time of sending the Neighbor Discover (ND) message.

Step 502: The PAR replies with a Proxy Router Advertisement (PrRtAdv) message, the message carrying the NAR information related to the newly discovered AP. The NAR information includes the L2 link address of the NAR, the IP address of the NAR, and the network prefix of the NAR.

Step 503: After the MN receives the PrRtAdv message, the MN generates a correlated NCoA according to the NAR network prefix information in the message: if the PrRtAdv message contains the recommended address, the MN uses the address as NCoA; if the PrRtAdv message contains no recommended address, the MN may generate its own NCoA through stateless auto configuration. When a new AP signal is increasingly stronger, the MN sends a Fast Binding Update (FBU) message to the PAR, with the NCoA of the MN carried in the message.

In the embodiment of the present disclosure, when the MN needs to move and hand over, an FBU message may be sent to the PAR, with the current PCoA carried in the FBU message.

In the embodiment of the present disclosure, in order to speed up the reconfiguration of the IP layer, the FBU message may also carry the recommended NCoA of the MN.

Step 504: After receiving the FBU message from the MN, the PAR modifies the PCoA host route of the MN, and the egress interface of the route leads out of the tunnel created from the PAR to the NAR, as exemplified below:
Ip route pcoa interface static_par_nar /* the egress interface of the host route addressed to the PCoA is the tunnel interface*/

This message is notified to the NAR through a HI message. The HI message carries the PCoA of the MN, the link-layer address and the recommended NCoA of the MN. In the embodiment of the present disclosure, after the PAR receives an FBU message of the MN, the PAR changes the host route addressed to the current PCoA, and sends a HI message to the NAR at the same time, with the message carrying the L2 link address of the MN, the current PCoA and the recommended NCoA, in order to forward the traffic of the message addressed to the PCoA out of the tunnel created between the PAR and the NAR. When a message addressed to the PCoA arrives, the PAR buffers the message.

Step 505: After receiving a HI message, the NAR checks validity of the NCoA address in the HI message, generates a proxy for NCoA, and crates a proxy neighbor list for the NCoA of the MN. In the present disclosure, the NAR needs to perform the neighbor discovery and response functions on behalf of both NCoA and PCoA of the MN. Therefore, the NAR also needs to create a proxy neighbor list for the current PCoA of the MN. The interface of the PCoA neighbor list ingress should be identical to the interface of the NCoA neighbor list. In this way, the NAR can forward the message correctly according to the PCoA proxy neighbor list after receiving a message addressed to the PCoA.

After receiving a message addressed to the PCoA, the NAR searches the PCoA proxy neighbor list. If no neighbor entry of the PCoA is found, the NAR discards the message; if a neighbor entry of the PCoA is found, the NAR sends the message to the MN.

In order to ensure the message sent by the NAR to be received by the MN, the NAR may buffer the data packet after searching out the neighbor entry of the PCoA.

In the embodiment of the present disclosure, if the HI message sent by the PAR carries the recommended NCoA, the NAR returns a Hack message after receiving a HI message.

Step 506: The PAR returns an FBack message to the MN. If the HI message sent by the PAR carries no recommended NCoA, skip step 506.

Step 507: When an MN moves to a link of the NAR, the MN sends an FNA message which carries the current PCoA options of the MN, in order to notify the NAR that the MN has arrived at a new link. In this way, the data packets buffered by the NAR can be sent to the MN.

After receiving an FNA message sent by the MN, the NAR creates an actual neighbor list for the NCoA and the PCoA of the MN; and creates a host route for the PCoA, as exemplified below:
Interface wireless_interface1
Neighbour ncoa lla_of mn
Neighbour pcoa lla_of mn
Exit
Ip route pcoa interface wireless_interface1 host /* creating a host route for the pcoa, and the egress interface is an radio interface*/

After the MN moves to the link of the NAR and before the binding update is finished, the following operations are performed according to the direction of the data packet:
A. Data packet sent from the MN to the CN:
the source address of the data packet is PCoA, the destination address is CN;
after receiving the data packet sent by the MN to the CN, the NAR sends the data packet to the CN directly through normal routing, without being sent to the PAR through tunneling.
B. Data packet sent from the CN to the MN:
the source address of the data packet is CN, the destination address is PCoA;
after the data packet is sent by the CN and arrives at the PAR, the PAR encapsulates the data packet according to the configured tunnel, and sends the traffic to the NAR; and
the NAR disassembles the data packet and sends it to the MN.

After completion of binding update, the MN notifies the PAR and the NAR of binding update completion, the PAR and the NAR delete the host route of the PCoA.

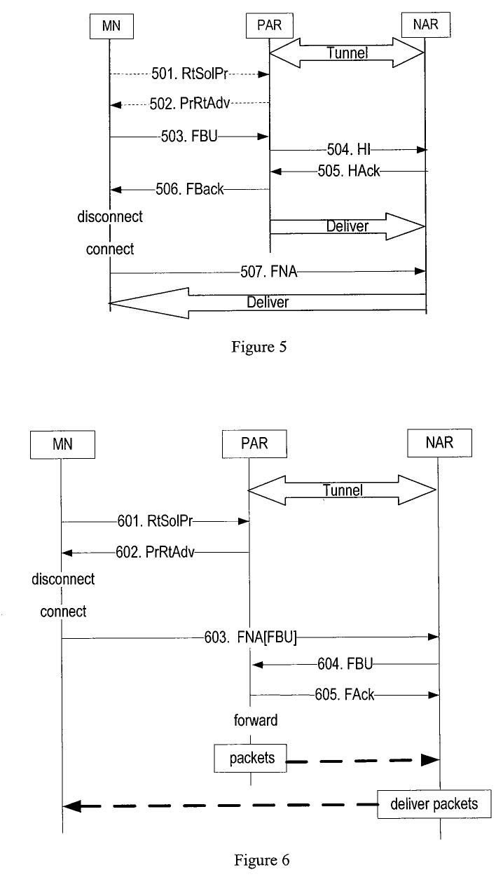

As shown in FIG. 6, the fast handover method in the reactive mode under the present disclosure includes the steps as described hereinafter.

Steps 601-602: The MN sends an RtSolPr message and receives a PrRtAdv message on the PAR link, and generates an NCoA address. Afterward, the MN hands over to the NAR link promptly (before receiving the FBU). The detailed process is elaborated hereinafter.

Step 603: The MN sends an FNA message to the NAR, the link-layer address of the MN being carried in the message. The FNA message also contains an FBU message.

Step 604: After receiving the FNA message, the NAR creates a neighbor entry and the corresponding host route for the NCoA and the PCoA, and sends an FBU message to the PAR.

Step 605: After receiving the FBU, the PAR modifies the host route of the PCoA, and sends the service packet addressed to the PCoA out of the tunnel between the PAR and the NAR. After completion of the foregoing operations, the PAR sends a FAck message to the NCoA address of the MN.

The fast handover signaling between the MN and the PAR and NAR is completed.

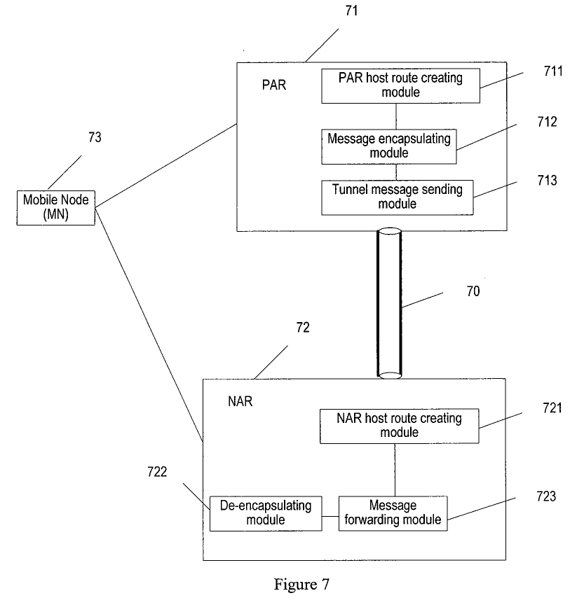

As shown in FIG. 7, a fast handover system provided in an embodiment of the present disclosure includes a Previous Access Router (PAR) 71, a New Access Router (NAR) 72, and a fixed tunnel 70 between the PAR 71 and the NAR 72.

The PAR 71 includes a PAR host route creating module 711, a message encapsulating module 712, and a tunnel message sending module 713.
The PAR host route creating module 711 is adapted to create a PCoA host route at the PAR by using the tunnel interface as an egress interface, after the PAR 71 receives a fast binding update message from the MN 73.
The message encapsulating module 712 is adapted to encapsulate the message received by the PAR 71, where the message is sent by the CN to the MN 73.
The tunnel message sending module 713 is adapted to send the message encapsulated by the message encapsulating module 712 to the NAR 72 through the tunnel;

The NAR 72 includes an NAR host route creating module 721, a de-encapsulating module 722, and a message forwarding module 723.
The NAR host route creating module 721 is adapted to create a PCoA host route at the NAR after the NAR 72 receives the Handover Init (HI) message sent by the PAR 71, with the ingress interface identical to the interface of NCoA proxy neighbor list. The PCoA host route does not take effect before the NAR 72 receives the Fast Neighbor Advertise (FNA) message sent by the MN 73, is designed only to buffer messages, and can be enabled and available for forwarding messages only after the NAR 72 receives the FNA message sent by the MN 73.
The de-encapsulated module 722 is adapted to de-encapsulate the message from the PAR 71 through the tunnel.
The actual message sending module 723 is adapted to send the message, which is de-encapsulated by the de-encapsulating module 722 and addressed to the PCoA, to the MN 73 according to the information in the actual proxy neighbor list of the NCoA; and send the message, which is received by the NAR 72 and sent by the MN 73 to the Correspondence Node (CN), to the CN according to the information in the proxy neighbor list of the NCoA.

Before handover of the MN 73, the MN 73 sends a binding update message to the PAR 71, with the PCoA carried in the message. After the PAR 71 receives the message, the PAR host route creating module 711 creates a PCoA host route of the MN according to the PCoA, with the egress interface of the PCoA host route identical to the interface of the tunnel. Meanwhile, the PAR 71 sends a HI message to the NAR 72, and notifies the NAR 72 of the PCoA.

After the NAR 72 receives the HI message, the NAR host route creating module 721 creates a PCoA host route of the MN, the ingress interface of the PCoA host route being identical to the interface of the NCoA proxy neighbor list.

In this way, when an MN 73 moves to NAR 72, the message can be transferred through the tunnel 70 before completion of the binding update, so as to communicate with the CN, as elaborated below:

After the NAR 72 receives a message sent by the MN 73 to its CN (the source address of the IP header of this message is the PCoA of the MN, and the destination address is the CN address), and the NAR 72 may send the message to the CN through a normal routing process according to its own NCoA host route.

After the PAR 71 receives the message sent by the CN to the MN 73 (the source address of the IP header of this message is the CN address, and the destination address is the PCoA address), the message encapsulating module 712 encapsulates the message according to the protocol adopted by the tunnel, and the tunnel message sending module 713 sends the encapsulated message to the NAR 72. After the NAR 72 receives the message, the de-encapsulating module 722 disassembles the message, and buffers the data packet. After receiving the FNA message from the MN 73, the NAR 72 determines that the MN 73 has moved to the link of the NAR. Now, the message forwarding module 723 sends the buffered data packet to the MN 73 according to the information in the proxy neighbor list of the PCoA.

The embodiment of the present disclosure also involves a host route information deleting module, which is adapted to delete the PCoA host route information related to the MN 73 in the PAR 71 and the NAR 72 after the MN 73 finishes the binding update.

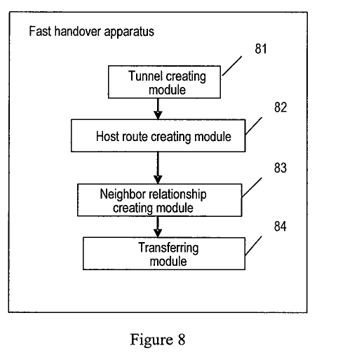

As shown in FIG. 8, a fast handover apparatus provided in an embodiment of the present disclosure includes:
a tunnel creating module 81, adapted to create a fixed tunnel relationship between the PAR and the NAR;
a host route creating module 82, adapted to create a current host route for the PCoA of the MN at the PAR and the NAR, specifically:
after the PAR receives the fast binding update message sent by the MN, create a PCoA host route at the PAR by using the tunnel interface as an egress interface;
after the NAR receives the HI message sent by the PAR, create a PCoA host route at the NAR, with the ingress interface identical to the interface of the NCoA proxy neighbor list, wherein the PCoA host route does not take effect before the NAR receives the FNA message from the MN, is designed only to buffer messages, and can be enabled and available for forwarding messages only after the NAR receives the FNA message from the MN;
a neighbor relationship creating module 83, adapted to create a proxy neighbor list at the NAR for the current PCoA of the MN;
in the embodiment of the present disclosure, if the HI message received by the NAR from the PAR carries the NCoA, the NAR creates a proxy neighbor list for the NCoA of the MN; and
a transferring module 84, adapted to transfer the data packet at the NAR to the MN according to the found proxy neighbor list.

A fast handover apparatus under the present disclosure may further include a FNA module (not illustrated in the figure herein), adapted to notify the NAR that the MN has arrived at a new link after the MN moves to a link of the NAR.

Step 507: When an MN sends an FNA, the FNA needs to carry the current PCoA options of the MN in order to notify the NAR that the MN has arrived at a new link. In this way, the data packets buffered by the NAR can be sent to the MN.

A fast handover apparatus under the present disclosure may further include a fast host information deleting module (not illustrated in the figure herein), adapted to delete the host route information of the PCoA in the PAR and NAR after the MN finishes the binding update.

Although the disclosure has been described through several preferred embodiments, the disclosure is not limited to such embodiments. It is apparent that those skilled in the art can make various modifications and variations to the disclosure without departing from the spirit and scope of the disclosure. The disclosure is intended to cover the variations and substitutions provided that they fall in the scope of protection defined by the following claims or their equivalents.

What is claimed is:

1. A fast handover method, comprising creating a fixed tunnel relationship between a Previous Access Router (PAR) and a New Access Router (NAR), the method further comprising:
creating a current host route of a Mobile Node (MN) at the PAR and NAR; and
encapsulating, by the PAR, NAR and MN, a message according to current host route information of an MN in an MN handover process, and transferring the message through a tunnel.

2. The fast handover method of claim 1, wherein the process of creating the current host route of the MN at the PAR and NAR comprises:
notifying, by the MN, the PAR of a Previous Care-of Address (PCoA);
modifying, by the PAR, a pre-stored direct host route of the MN according to the PCoA, setting an egress interface of the host route as a tunnel interface, and notifying the NAR of the PCoA; and
creating the current host route of the MN according to the PCoA.

3. The fast handover method of claim 2, wherein:
the MN notifies the PAR of the PCoA through a binding update message.

4. The fast handover method of claim 3, wherein:
the PAR notifies the NAR of the PCoA through a Handover Initiation (HI) message.

5. The fast handover method of claim 4, wherein:
the binding update message and the HI message further comprise an New Care-of Address (NCoA);
the creating of the current host route of the MN according to the PCoA comprises:
creating, by the NAR, a proxy neighbor list for the NCoA and the PCoA of the MN respectively, an ingress interface of the PCoA proxy neighbor list being identical to an interface of the NCoA proxy neighbor list.

6. The fast handover method of claim 5, wherein the encapsulating of messages according to the current host route information of the MN and transfer messages through the tunnel comprises:
sending, by the MN, a message to a Correspondence Node (CN), wherein a source address of an IP header of the message is the PCoA of the MN and a destination address is a CN address; and
sending, by the NAR, a message to the CN according to information in the NCoA proxy neighbor list after receiving the message sent by the MN to the CN.

7. The fast handover method of claim 5, wherein the encapsulating of messages according to the current host route information of the MN and transfer messages through the tunnel further comprises:
sending, by the CN, a message to the MN, wherein the source address of the IP header of the message is the CN address and the destination address is the PCoA of the MN;
sending, by the NAR, a message to the NAR through a tunnel after receiving the message sent by the CN to the MN; and
de-encapsulating the received message, and sending the disassembled message to the MN.

8. The fast handover method of claim 7, wherein:
the NAR sends the disassembled message addressed to the PCoA to the MN according to the PCoA proxy neighbor list.

9. The fast handover method of claim 8, wherein the sending of the disassembled message addressed to the PCoA to the MN according to the PCoA proxy neighbor list, comprises:
obtaining, by the NAR, the address information of the MN by searching the PCoA proxy neighbor list, and buffering the data packet; and
sending the buffered data packet to the MN after determining that the MN has moved to the link of the NAR.

10. The fast handover method of claim 9, wherein:
after receiving the FNA message from the MN, the NAR determines that the MN has moved to the link of the NAR.

11. The fast handover method of claim 1, further comprising:
sending, by the MN, a binding update completion message to the PAR and NAR after the MN finishes the binding update; and
deleting, by the PAR and NAR, the stored PCoA host route of the MN after receiving the message.

12. A fast handover system, comprising: a Previous Access Router (PAR), a New Access Router (NAR), and a fixed tunnel between the PAR and the NAR:
the PAR comprises:
a PAR host route creating module, adapted to create a PCoA host route at the PAR by using a tunnel interface as an egress interface, after receiving a fast binding update message from a Mobile Node (MN);
the NAR comprises:
an NAR host route creating module, adapted to create a PCoA host route at the NAR after receiving a Handover Initiation (HI) message from the PAR, with the ingress interface identical to the interface of an NCoA proxy neighbor list.

13. The system of claim 12, wherein:
the PAR further comprises:
a message encapsulating module, adapted to encapsulate a message sent by a Correspondence Node (CN) to the MN; and
a tunnel message sending module, adapted to send the message encapsulated by the message encapsulating module to the NAR through the tunnel;
the NAR further comprises:
a de-encapsulating module, adapted to de-encapsulating the message received from the PAR through the tunnel; and
a message forwarding module, adapted to send the message, which is de-encapsulated by the de-encapsulating module and addressed to the PCoA, to the MN according to the information in the actual proxy neighbor list of the NCoA; and send the message, which is received by the NAR and is sent by the MN to the CN, to the CN according to the information in the actual proxy neighbor list of the NCoA.

14. The system of claim 12, further comprising:
a host route information deleting module, adapted to delete the PCoA host route information related to the MN in the PAR and NAR after the MN finishes the binding update.

15. A router, comprising:
a host route creating module, adapted to create a PCoA host route by using a tunnel interface as an egress interface, after receiving a fast binding update message from a Mobile Node (MN);
a message encapsulating module, adapted to encapsulate a message sent by a Correspondence Node (CN) to the MN; and
a tunnel message sending module, adapted to send the message encapsulated by the message encapsulating module to the NAR through the tunnel.

16. A router, comprising:
an host route creating module, adapted to create a PCoA host route after receiving a Handover Initiation (HI) message from the PAR, with the ingress interface identical to the interface of an NCoA proxy neighbor list.
a de-encapsulating module, adapted to de-encapsulate the message received from the PAR through a tunnel; and
a message forwarding module, adapted to send the message, which is de-encapsulated by the de-encapsulating module and addressed to the PCoA, to the MN according to the information in the actual proxy neighbor list of the NCoA; and send a message, which is sent by the MN to the CN, to the CN according to the information in the actual proxy neighbor list of the NCoA.

17. The fast handover method of claim 6, wherein the encapsulating of messages according to the current host route information of the MN and transfer messages through the tunnel further comprises:
sending, by the CN, a message to the MN, wherein the source address of the IP header of the message is the CN address and the destination address is the PCoA of the MN;
sending, by the NAR, a message to the NAR through a tunnel after receiving the message sent by the CN to the MN; and
de-encapsulating the received message, and sending the disassembled message to the MN.

18. The fast handover method of claim 17, wherein:
the NAR sends the disassembled message addressed to the PCoA to the MN according to the PCoA proxy neighbor list.

19. The fast handover method of claim 18, wherein the sending of the disassembled message addressed to the PCoA to the MN according to the PCoA proxy neighbor list, comprises:
obtaining, by the NAR, the address information of the MN by searching the PCoA proxy neighbor list, and buffering the data packet; and
sending the buffered data packet to the MN after determining that the MN has moved to the link of the NAR.

20. The fast handover method of claim 19, wherein:
after receiving the FNA message from the MN, the NAR determines that the MN has moved to the link of the NAR.
